(19) United States
(12) Patent Application Publication
(10) Pub. No.: US 2007/0030609 A1
(43) Pub. Date: Feb. 8, 2007

(54) Methods, devices and systems for protecting RFID reader front ends

(75) Inventor: Matthew Stephen Reynolds, Medford, MA (US)

Correspondence Address: DAVIDSON BERQUIST JACKSON & GOWDEY LLP, 4300 WILSON BLVD., 7TH FLOOR, ARLINGTON, VA, 22203, US

(73) Assignee: ThingMagic, Inc., Cambridge, MA (US)

(21) Appl. No.: 11/195,763

(22) Filed: Aug. 3, 2005

(51) Int. Cl. H02H 9/00

(52) U.S. Cl. 361/56

(57) ABSTRACT

An RFID protection scheme includes monitoring an output signal of a least one receiver mixer of the reader, and, based at least in part on said monitoring, when said output signal exceeds a predetermined threshold, performing one or more of the following: removing an RF signal from a transmitter power amplifier (PA); removing a bias from the PA; causing a protection switch to divert transmitter power away from an antenna circuit; and signaling a processor to reduce transmitter power.

### FIELD OF THE INVENTION

This invention relates to Radio Frequency Identification (RFID) readers.

### BRIEF DESCRIPTION OF THE DRAWINGS

The invention is better understood by reading the following detailed description with reference to the accompanying drawings in which:

FIGS. 1-4 depict RFID readers incorporating protection solutions;

FIG. 5 depicts RFID readers according to embodiments of the present invention;

FIG. 6 is a flowchart of the operation of embodiments of the present invention; and

FIG. 7 depicts an RFID reader according to embodiments of the present invention.

### DESCRIPTION OF PRESENTLY PREFERRED EXEMPLARY EMBODIMENTS

### Background and Overview

RFID readers are rather unique among communication systems in that they typically transmit and receive simultaneously, on the same frequency, usually using a homodyne or superheterodyne receiver topology. In a monostatic RFID reader system (single antenna, combined transmit and receive), the fact that the RFID reader's transmitter is active while the receiver is connected to the same antenna introduces a potential failure mode. This is because a damaged cable connection between the reader and the antenna may result in reflection of most of the transmitter's output power back into the receiver's input port.

Since a typical RFID reader transmitter has an output power of about 1 Watt (+30 dBm) while the mixer burnout threshold for a typical RFID reader's front-end mixer is about 100 mW (+20 dBm), terminating a monostatic RFID reader's antenna port in a return loss of less than 10 dB can lead to mixer burnout within an extremely short time (nanoseconds to microseconds). An RF short circuit or an RF open circuit correspond to a return loss of 0 dB, meaning all of the transmitted power is reflected back to the receiver. A (typically safe) return loss of 10 dB would result in a reflection of only about 10% of the transmitted power back to the receiver. An unconnected or broken cable connection between the reader and the antenna can thus lead to catastrophic failure of the RFID reader's receiver because of excess reflected power.

A similar problem of receiver damage may occur in a bistatic RFID reader (separate transmit/receive antenna) if the reader's antenna is damaged in a way that results in unusually low transmit-receive isolation, or if an installer accidentally connects the reader's transmitter output to its receiver input.

Attempting to transmit into an un-terminated antenna port is not an infrequent event during installation or maintenance, when the reader's installer is busy connecting and disconnecting antennas. It can also occur if a cable or antenna is broken during use, for example by a forklift accident or by a human accidentally bumping into the antenna cables.

Accordingly, in one aspect, this invention provides methods and devices for preventing RFID receiver burnout by detecting a mismatched antenna port condition and reacting to sufficiently quickly (generally as quickly as possible) in order to prevent damage to the reader.

In another aspect, this invention provides an antenna integrity monitoring signal to the RFID reader's processor, so that a disconnected antenna will cause a fault notification from the RFID reader system to a human, or to a higher-level software system that manages RFID readers.

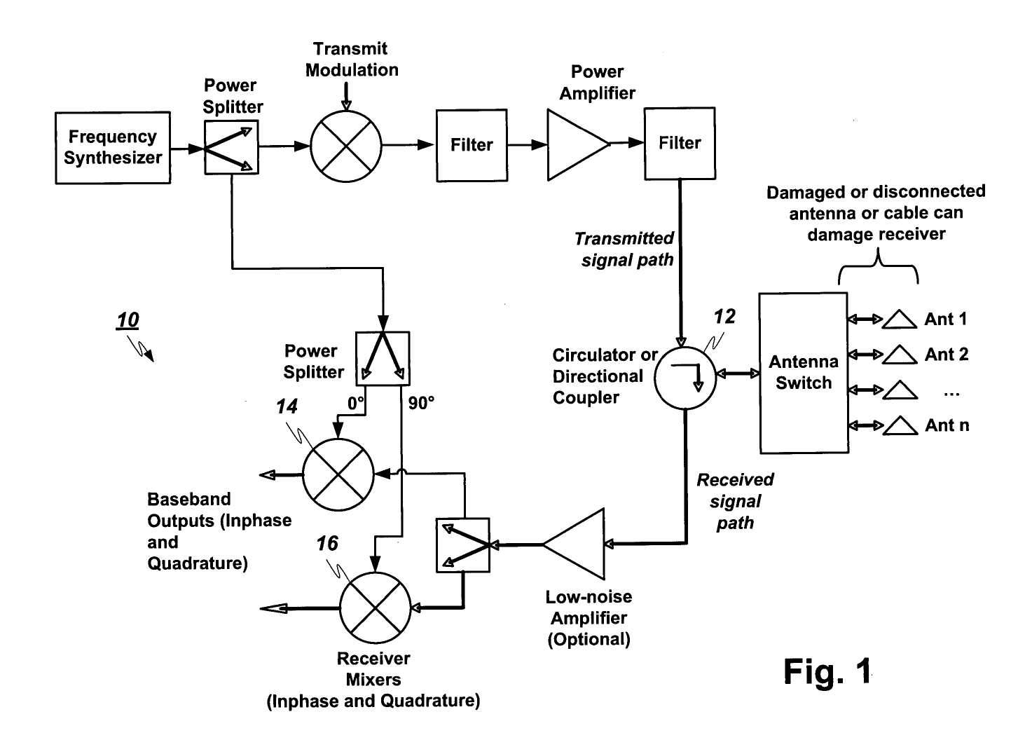

FIG. 1 shows a block diagram of the radio portion of a traditional monostatic (single antenna combined transmit/receive) RFID reader system, generally denoted 10. The failure mode mentioned herein is immediately apparent—if an antenna (Ant₁, Ant₂, . . . , Antₙ) becomes disconnected for any reason, the transmitter's power is reflected back from the un-terminated port, traveling back through the reverse path of the circulator or directional coupler 12, and appearing at the input port of the receiver's mixer 14, 16.

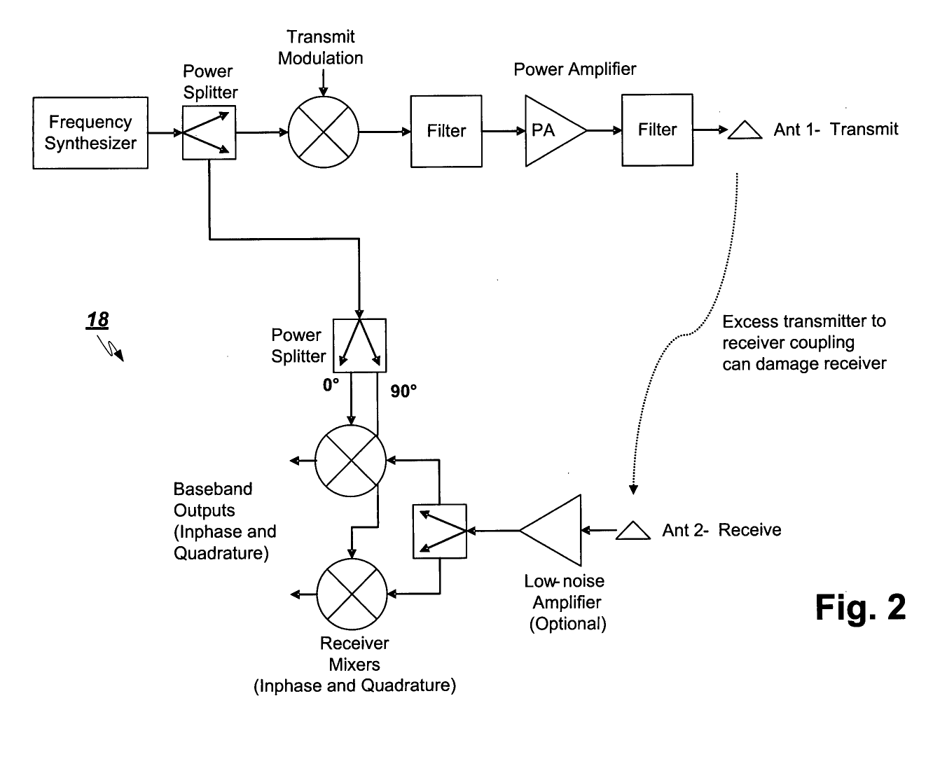

In the case of a bistatic (separate transmit/receive antennas) RFID reader, e.g., reader 18 as shown in FIG. 2, an antenna failure could result in less isolation between the transmitter and receiver than was originally intended, or an installer might inadvertently connect the transmitter and receiver ports together.

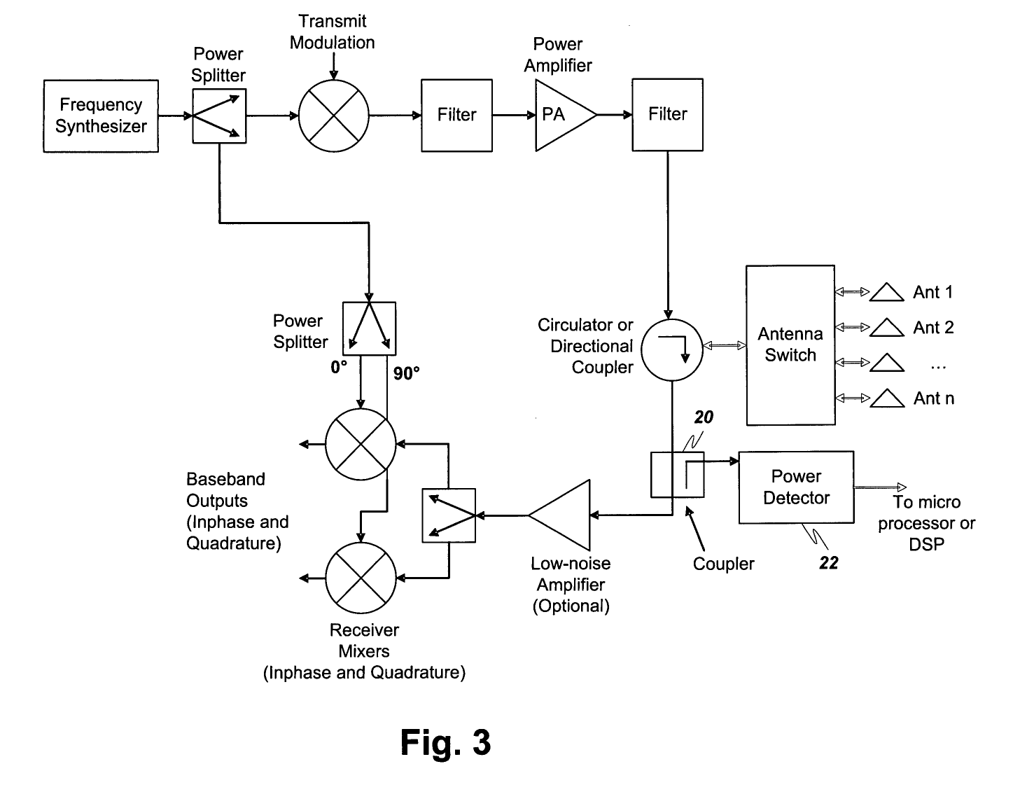

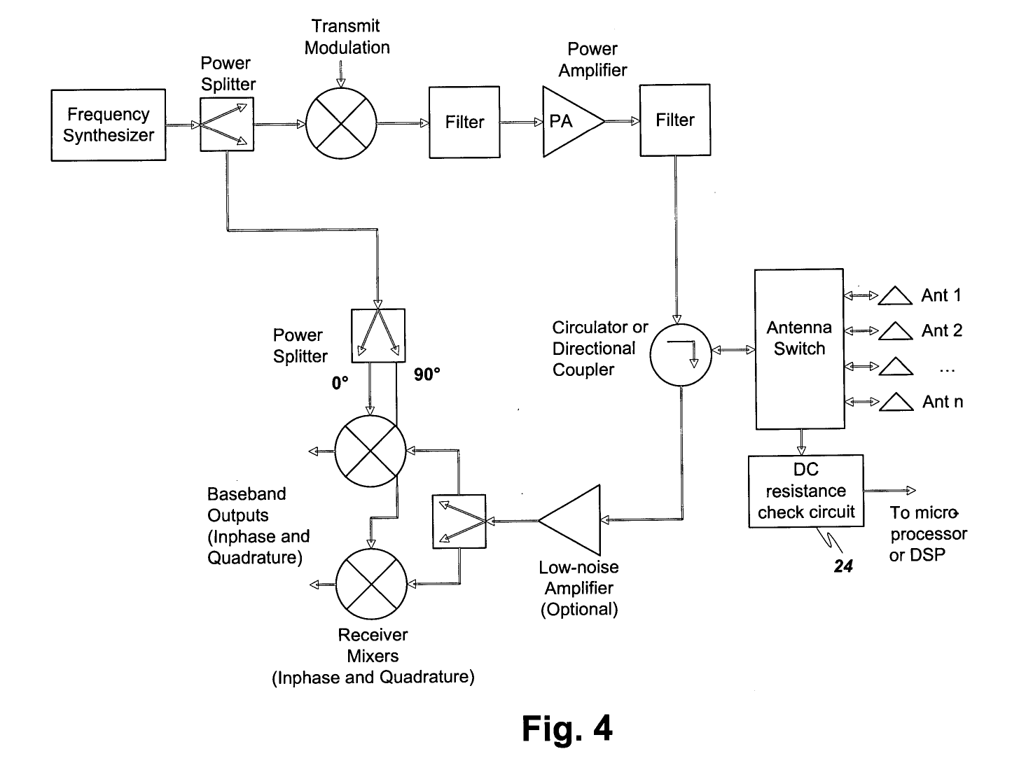

Solutions to this problem are shown in FIGS. 3 and 4. As shown in the block diagram of FIG. 3, a directional coupler 20 is introduced into the receiver path, and a small fraction (e.g., −20 dB, or 1%) of the received signal is coupled to a fast-responding power detector. In the event of an antenna termination failure, an unusually large amount of RF power is observed at this port, and a failure is signaled to the RFID reader's processor (not shown), which can then shut off the transmitter.

A different scheme is employed in the system shown in FIG. 4. This scheme depends on the reader's antenna having a certain DC resistance. In this scheme, the RF properties of the antenna are not checked. Rather, a DC circuit 24 is established that is independent of the RF path. Thus, while the antenna may present a 50 ohm impedance to an RF signal, it presents a different DC resistance (e.g., a short circuit, 50 ohms DC, or 10 KOhms DC). An inductor such as an RF choke, or a resistor is used to isolate the DC “antenna presence” voltage or current, from the RF transmit signal that is destined for the antenna. A comparator or threshold circuit, or an analog-to-digital converter operating with a software threshold, is used to verify the presence of a certain DC resistance.

The methods shown in FIGS. 3 and 4 have significant drawbacks. A primary problem is the cost and complexity associated with the additional components needed for either solution. A secondary issues associated with these approaches include the loss of received signal caused by the insertion loss of the added directional coupler (in the FIG. 3 approach), and the fact that the DC resistance of the antenna does not necessarily correlate with its RF properties (in the FIG. 4 approach). In the latter case, there are numerous mechanical failure modes (such as a partially cut cable, or a loose antenna element) within the coaxial cable or the antenna itself that would yield an acceptable DC reading, but which would present an unacceptable termination to the RFID reader.

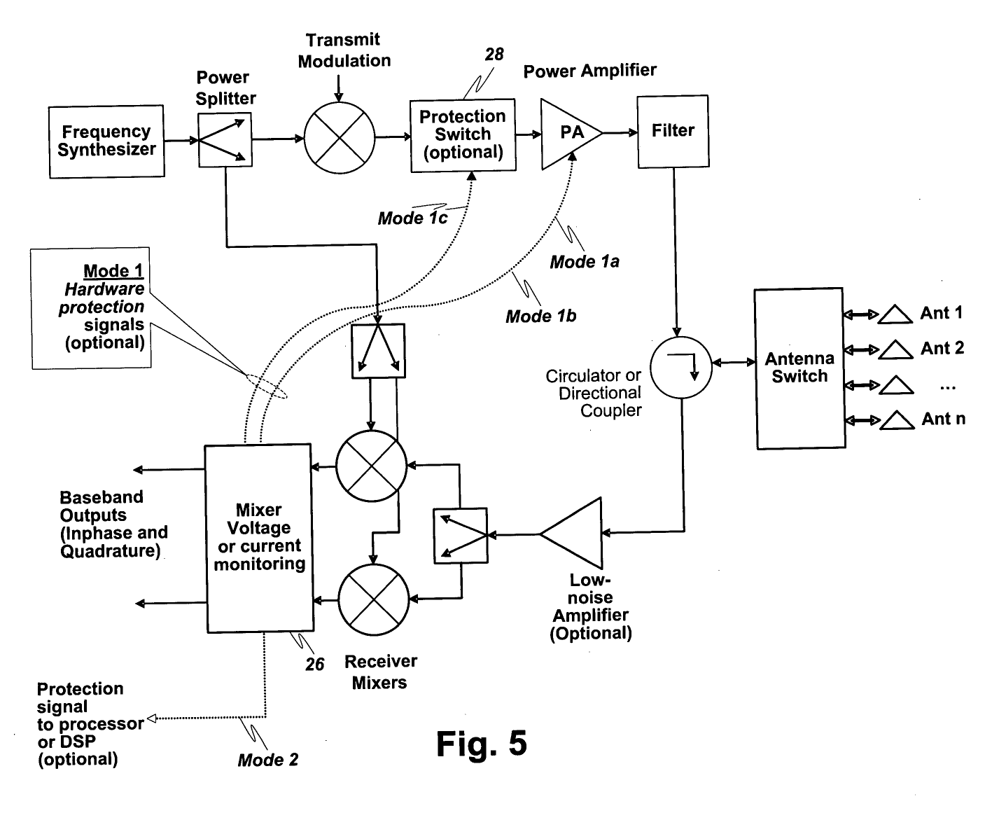

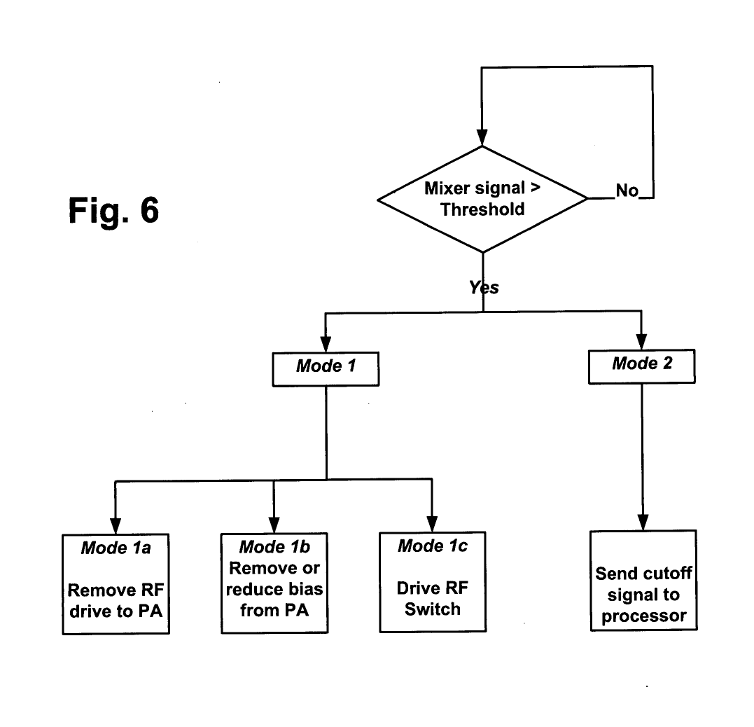

FIG. 5 is a block diagram of an RFID reader 24 according to embodiments of the present invention. The approach shown in the reader of FIG. 5 avoids the drawbacks of those shown in the readers of FIGS. 3-4. As is apparent from the figure, the signal indicating the RF power incident on the mixer is derived from the mixer itself, in the form of mixer diode (or transistor) current I, or mixer diode (or transistor) voltage V. This signal occurs because, in the event of antenna or cable failure, the incident RF signal from the transmitter artificially increases the DC bias current (or voltage) of the mixer(s), because the excess transmitter signal is rectified by the mixer diodes (or transistors). This signal is then processed by an analog or digital processing circuit and may be used in one or both of the following two modes (with reference also to the flowchart in FIG. 6):

In Mode 1, labeled “Hardware protection” in FIG. 5, the mixer signal is thresholded using a fast comparator circuit 26 that is set to detect when the RF signal incident upon the mixer exceeds a predetermined threshold, where this threshold is set to a value less than that of the damage threshold for the receiver. This thresholded signal is used in one or more of the following three ways:
In Mode 1a, the threshold signal removes or reduces the RF drive provided to the transmitter power amplifier (PA), for example by means of a fast RF switch such as a silicon or gallium arsenide (GaAs) switch or attenuator.
In Mode 1b, the thresholded signal removes or reduces the bias from the power amplifier, thus reducing the power amplifier gain to a point at which the PA no longer produces enough RF power to damage the receiver.
In Mode 1c, the thresholded signal drives an RF protection switch 28 that either shunts the transmitter power into a terminating (dummy) load rather than into the antenna circuit, or switches the receiver input port into a termination rather than into the mixer diodes.

It should be appreciated that any or all of these methods may be used singly or in combination to achieve the required response time to prevent receiver damage. The choice of which mode or modes are used is one of receiver design.

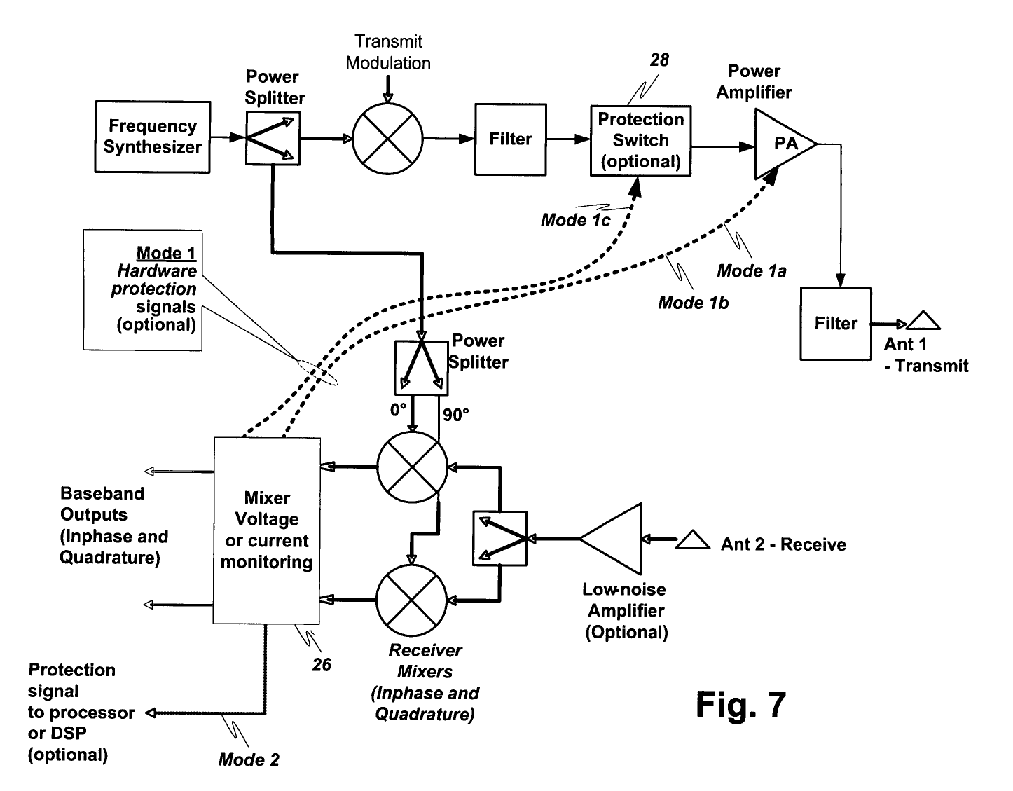

Certain elements in FIGS. 5 and 7 are labeled “optional.” Those skilled in the art will realize when these elements will be needed or used. For example, the protection switch 28 in FIGS. 5 and 7 is needed when Mode 1c is implemented; the protection signal to the processor or DSP is needed when Mode 2 is implemented; and the hardware protection signals are implemented when some aspect of Mode 1 is implemented.

In Mode 2, the mixer signal due to the reader's transmitter is either thresholded into a binary (single-bit) value, or digitized into a multi-bit digital representation of an analog voltage. This signal is then used as an input to the reader's microprocessor (or DSP) (not shown), for example as an input to a software power servo loop. In this case, during its operation, the software power servo loop checks the value of the mixer signal against a software threshold and does not permit the transmitter power to exceed the safe region of operation. Alternatively, the reader's software might check the mixer signal either periodically, or at any time the software changes the operating parameters of the reader hardware. Furthermore, this digitized mixer signal could also be used as an interrupt input to the microprocessor or DSP to signal a fault asynchronously.

These two modes (Mode 1 and Mode 2) have properties that make it desirable to employ them in concert. Clearly, if it is desirable for the reader to make a notification to the user that an antenna circuit fault has occurred, at least Mode 2 should be employed, to give the reader's microprocessor or DSP a signal that the mixer(s) are (or may be) on the verge of destruction. However, because of the finite processing speed required for the microprocessor to act on this notification and shut down the transmitter, it may be too late to prevent near-instantaneous destruction of the receiver system. This may be especially true if the reader's processor is busy with other processing tasks at the time the fault occurs.

The approaches of Mode 1 take the reader's processor out of the shutdown loop by connecting the mixer monitoring circuit to the transmitter directly, and by providing high-speed methods of inhibiting the transmitter, such as by disabling the power amplifier (Mode 1b) or by switching off various signal paths (Mode 1a or 1c). These high speed switching tasks can be performed on a time scale (nanoseconds to microseconds, depending on the particulars of the design) which can act in sufficient time to save the receiver from destruction. However the Mode 1 approaches, if not used in combination with Mode 2, do not include notification of the reader's processor that a fault has occurred. Thus, a combination of the two modes should preferentially be employed.

It should be appreciated that there are many ways of detecting excess transmitter power impinging upon the mixer(s), including measuring mixer current or voltages using a high impedance opamp (operational amplifier) or comparator circuit, employing a transimpedance amplifier or resistor to convert mixer current to voltage, or employing a peak detector circuit to capture the peak value of such a current or voltage.

Furthermore, the mixer signal may be either sliced to a binary indication (mixer signal exceeds safe values, or not) or it may be digitized by an analog-to-digital converter (ADC) and its derivative or absolute value examined by either a hardware or software means.

Still further, there are many ways of disabling the transmitter including those mentioned (switching the signal paths, or the power amplifier bias), or by employing any means known to switch either DC or RF signals, including FETs (field-effect transistors), bipolar transistors, PIN (Positive-Intrinsic-Negative) diodes, switching diodes, relays, etc.

Additionally, should a low noise amplifier (LNA) or other fragile active or passive device be employed in the circuit ahead of the mixer(s), the threshold of damage to those components can be used instead of the mixer threshold of damage, should they be more vulnerable than the mixer(s) in any given design.

This approach is equally useful either in the monostatic case shown in FIG. 5, or in the bistatic case (as shown in FIG. 6).

The argument about mixer current monitoring also applies to the use of the LNA or other fragile device such as an integrated circuit, diode, or transistor, (or, in fact, any device having a non-linear transfer function), as a mixer for the purpose of extracting the burnout monitoring signals.

It should also be appreciated that combinations of these approaches, as implemented either in the analog or digital domain, or in hardware or software, have been explicitly recognized and contemplated herein. The integration of these functions into an integrated circuit is also contemplated.

It should also be appreciated that the approaches described with reference to FIGS. 5-7 may also be used in combination with approaches described in FIGS. 1-4.

The present invention thus provides a relatively simple and straightforward method of adding a significant level of burnout protection to an RFID reader front end. It is also an inexpensive method, since it makes use of the existing mixer elements (or the parasitic mixers formed by the LNA or other nonlinear devices) to provide the signals needed to determine whether their own burnout is imminent. Furthermore, the reaction time of this circuit can be extremely fast, especially if a direct feedback from the monitoring circuit to the transmitter circuit is employed, so that the front end is exposed to an excessive-power condition for the minimum possible time and thus maximizing their chance of survival.

Thus is provided description of the invention, and of the manner and process of making and using it. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

I claim:

1. A method of protecting circuitry of an radio frequency identification reader, the method comprising:
monitoring an output signal of a least one receiver mixer of the reader, and, based at least in part on said monitoring, when said output signal exceeds a predetermined threshold, performing one or more of the following:
(a) reducing or removing an RF signal from a transmitter power amplifier (PA);
(b) reducing or removing a bias from the PA;
(c) causing a protection switch to divert transmitter power away from an antenna circuit; and
(d) signaling a processor to indicate that said output signal has exceeded said predetermined threshold.

2. A method as in claim 1 wherein said step (a) comprises:
removing or reducing the RF drive signal using at least one of a silicon, PIN (Positive-Intrinsic-Negative), or gallium arsenide (GaAs) switch or attenuator.

3. An Radio Frequency Identification (RFID) reader comprising:
(A) first circuitry providing a first RF signal to at least one antenna connected thereto to cause said antenna to emit an RF signal, said first circuitry including a transmitter power amplifier;
(B) second circuitry for reading a second RF signal for an antenna connected thereto; and
(C) a protection mechanism connected to an output of said second circuitry and constructed and adapted to prevent said second signal from damaging said first or said second circuitry.

4. An RFID reader as in claim 3 wherein the protection mechanism is constructed and adapted to monitor the second RF signal, and, in response to said monitoring, when said second RF signal exceeds a predetermined threshold, to reduce the first RF signal from the transmitter power amplifier.

5. An RFID reader as in claim 3 wherein the protection mechanism is constructed and adapted to monitor the second RF signal, and, in response to said monitoring, when said second RF signal exceeds a predetermined threshold, to remove the first RF signal from the transmitter power amplifier.

6. An RFID reader as in claim 3 wherein the protection mechanism is constructed and adapted to monitor the second RF signal, and, in response to said monitoring, when said second RF signal exceeds a predetermined threshold, to reduce a bias from the transmitter power amplifier.

7. An RFID reader as in claim 3 wherein the protection mechanism is constructed and adapted to monitor the second RF signal, and, in response to said monitoring, when said second RF signal exceeds a predetermined threshold, to remove a bias from the transmitter power amplifier.

8. An RFID reader as in claim 3 wherein said first circuitry further comprises a protector switch, and wherein the protection mechanism is constructed and adapted to monitor the second RF signal, and, in response to said monitoring, when said second RF signal exceeds a predetermined threshold, to causing said protection switch to divert at least some transmitter power away from an antenna circuit.

9. An RFID reader as in claim 3 wherein said first circuitry further comprises a protector switch, and wherein the protection mechanism is constructed and adapted to monitor the second RF signal, and, in response to said monitoring, when said second RF signal exceeds a predetermined threshold, to signal a processor to reduce transmitter power of said first RF signal.
